(19) United States
(12) Patent Application Publication
(10) Pub. No.: US 2019/0369837 A1
(43) Pub. Date: Dec. 5, 2019

(54) METHODS AND SYSTEM FOR REDUCING IMPLICIT BIAS WITH VIRTUAL ENVIRONMENTS

(71) Applicant: Bridgette Davis, Oxon Hill, MD (US)

(72) Inventor: Bridgette Davis, Oxon Hill, MD (US)

(21) Appl. No.: 16/168,460

(22) Filed: Oct. 23, 2018

Related U.S. Application Data
(60) Provisional application No. 62/679,807, filed on Jun. 2, 2018.

(51) Int. Cl. G06F 3/0481; G06F 3/01; G06K 9/00; H04N 7/15

(52) U.S. Cl. CPC G06F 3/04815; H04N 7/157; G06K 9/00671; G06F 3/011

(57) ABSTRACT

Methods and systems are disclosed for reducing biased attitudes using virtual environments. The methods and system comprise accessing a virtual environment that includes 360 degree images of one or more real-world environments; receiving a selection of one or more de-biasing exercises; executing the selected one or more de-biasing exercises within the virtual environment, wherein executing the selected one or more de-biasing exercises reduces a biased attitude of the user; and repeating the selected one or more de-biasing exercises, wherein repeating the selected one or more de-biasing exercises replaces the biased attitude with an unbiased attitude.

### CROSS REFERENCE TO RELATED APPLICATIONS

The present application claims priority to U.S. Provisional Application No. 62/679,807 filed on Jun. 6, 2018, entitled “Method And Process For Presenting 360 Video Environment For Interaction With Video Produced Characters,” the disclosure of which is hereby incorporated by reference in its entirety and for all purposes.

### TECHNICAL FIELD

The present invention relates generally to reducing implicit bias, and more particularly to generating virtual environments that reduce implicit bias.

### BACKGROUND

Most people carry implicit biases to various social groups based on their individual experiences and social interactions through their lives. An implicit bias may be an unconscious attribution of particular qualities to a member of a certain social group. The social group is often one in which a person does not belong such as a s social of a different race, religion, gender, sexual orientation, career, disability, weight, etc. Implicit bias affect how different social groups communicate or otherwise interact with each other which can often lead to negative consequences for one or both groups. This may especially be the case for marginalized and minority groups that may lack access to social services or justice due to implicit biases of the larger social groups. Past methods and systems that evaluated and address implicit bias in individuals and groups often failed to provide meaning result. Either biased attitudes persisted beyond the implicit bias training or the biased attitude would reemerge after the training. Thus, methods and systems are needed to improve the detection, evaluation, and treatment of biases in individuals and groups.

### SUMMARY

A method is disclosed for reducing biased attitudes of users using virtual environments. The method includes accessing a virtual environment that includes 360 degree images of one or more real-world environments; receiving a selection of one or more de-biasing exercises; executing the selected one or more de-biasing exercises within the virtual environment, wherein executing the selected one or more de-biasing exercises reduces a biased attitude of the user; and repeating the selected one or more de-biasing exercises, wherein repeating the selected one or more de-biasing exercises replaces the biased attitude with an unbiased attitude.

A system is disclosed for reducing biased attitudes of users using virtual environments. The system includes one or more processors and a non-transitory computer-readable media including instructions, which when executed by the one or more processors, cause the one or more processors to perform operations including: accessing a virtual environment that includes 360 degree images of one or more real-world environments; receiving a selection of one or more de-biasing exercises; executing the selected one or more de-biasing exercises within the virtual environment, wherein executing the selected one or more de-biasing exercises reduces a biased attitude of the user; and repeating the selected one or more de-biasing exercises, wherein repeating the selected one or more de-biasing exercises replaces the biased attitude with an unbiased attitude.

A non-transitory computer-readable media that includes instructions, which when executed by the one or more processors, cause the one or more processors to perform operations that reduce biased attitudes of users using virtual environments. The operations including: accessing a virtual environment that includes 360 degree images of one or more real-world environments; receiving a selection of one or more de-biasing exercises; executing the selected one or more de-biasing exercises within the virtual environment, wherein executing the selected one or more de-biasing exercises reduces a biased attitude of the user; and repeating the selected one or more de-biasing exercises, wherein repeating the selected one or more de-biasing exercises replaces the biased attitude with an unbiased attitude.

Numerous benefits are achieved by way of the present disclosure over conventional techniques. For example, the invention advantageously provides an illusion of immersing a user (e.g., a human operator) in a real-world video scene using a virtual environment where the user is able to interact with realistic video characters and have those characters respond to the user. The virtual environment is self-motivating, fun, and immersive which produces a greater debasing effect than simply learning about bias or trying to consciously reduce bias.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is exemplary block diagram of an electronic device according to certain aspects of the present disclosure.

FIG. 2 is exemplary block diagram of a server according to certain aspects of the present disclosure.

FIG. 3 is exemplary flowchart of a process for reducing implicit bias using virtual environments according to certain aspects of the present disclosure.

FIG. 4 is exemplary flowchart of a process for reducing implicit bias using virtual environments according to certain aspects of the present disclosure.

FIG. 5 is an exemplary visual appearance of a virtual environment as it appears to a user according to certain aspects of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

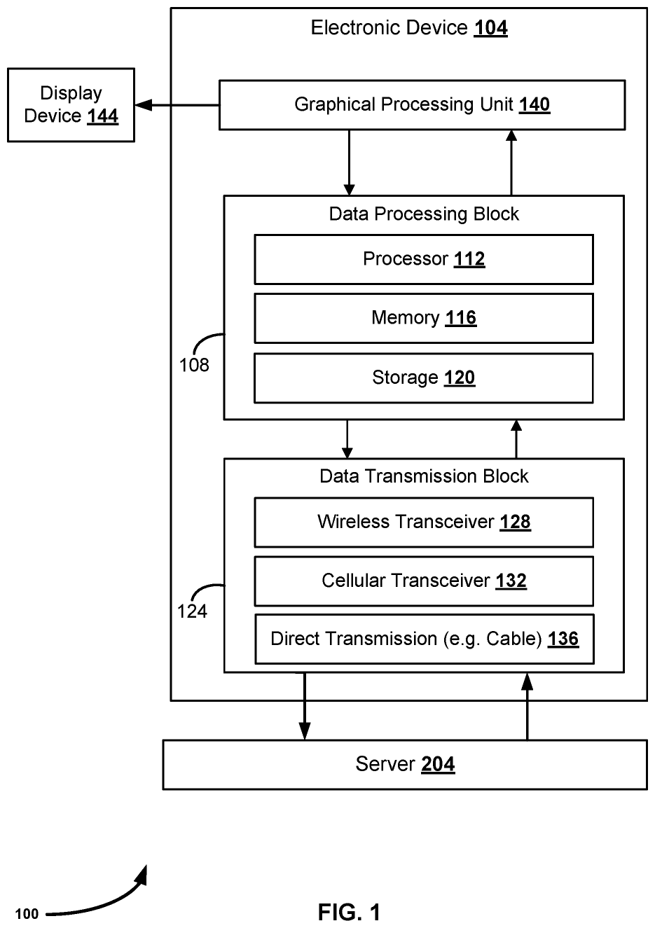

FIG. 1 is exemplary block diagram 100 of an electronic device 104 having plurality of components that operate to enable the electronic device 104 to access a virtual environment. As used herein, a virtual environment is a two dimensional, three dimensional, or virtual reality graphical environment. Users may access a virtual environment in the first person or the third person and be represented within the environment as themselves, selected character, a member of marginalized group, etc. Electronic device 104 (e.g., mobile device, laptop, desktop, server, etc.) may include a data processing block 108, a data transmission block 124, and a graphical processing unit (GPU) 140. Electronic device 104 may additionally include a sensor data block (not shown) which may include input/output interfaces (e.g., mouse, keyboard, touchscreen etc.) and/or data collection sensors (e.g., microphones, video cameras, accelerometers, gyroscopes, thermometers, etc.). Sensor data block can include external devices connected via Bluetooth, USB cable, etc. The data processing block 108 may include storage 120, and manipulations done to the data obtained from the sensor data block by processor 112. This may include, but is not limited to, analyzing, characterizing, subsampling, filtering, reformatting, etc.

Electronic device 104 includes one or more data transmission blocks 124 each configured to send or receive signals. A data transmission block 124 enables any transmissions of data to or from the electronic device 104. Data may be transmitted or received by wireless transceivers 128, cellular transceivers 132, or by direct transmission (e.g., through a cable or other wired connection) 136. Electronic device 104 may communicate with one or more remote devices such as other electronic devices, servers (e.g., server 204) and the like. Server 204 may include processors, volatile and non-volatile memories, input/output interfaces, data transmission blocks and/or the like.

Graphical processing unit (GPU) 140 is a specialized electronic circuit that may include one or more processors, processing cores, and memories. GPU 140 may generate images in a frame buffer (not shown) that is then output to a display device. In some examples, GPU 140 may generate some or all of an instance of a virtual environment. In other examples, GPU 140 may operate in conjunction with data processing block 108 to generate some or all of the virtual environment. In still yet other examples, the virtual environment may be generated by a remote device and accessed by electronic device 104 (e.g., electronic device 104 may operate as a thin client where the process occurs at the server and rendered by electronic device 104). A virtual environment may be generated from instructions, two or three dimensional images, and/or two or three dimensional videos that are stored in storage 120 or received by data transmission block 124 from one or more remote devices. In some examples, data processing block 108 may transmit instructions to GPU 140 to generate new images and/or environments without using a pre-recorded image.

Electronic device 104 may use a pixel processor (not shown) to analyze portions of an image to generate seamless transitions between images and other images or images and video. For example, two images of the same environment taken from different angles may be merged to using the pixel processor to generate a single (seamless) image. GPU 140 may use the pixel processor to overlay frames of video on top of the virtual environment to simulate movement without dynamic rendering animation. The pixel processor may modify the pixels of each frame of video and the pixels of an image such that video appears to play seamlessly within the image. This may advantageously enable generating complex virtual environments with less processing resources as the GPU does not need to provide dynamic texture mapping to create new polygons to render a dynamic virtual environment.

In some examples, electronic devices may each include all of the instructions, images, and videos to generate an individual instance of the virtual environment. Multiple electronic devices and/or servers may access the same instance of a virtual environment even though each electronic device and server operates its own version of the virtual environment. To maintain a synchronized state among the different devices, electronic devices may transmit communications to other electronic devices and/or servers operating the same instance. The communications may include an full state or a delta (e.g., the difference between the current state and the change in the state caused by an electronic device). In other examples, the server may operate as a central exchange to synchronize the state of one or more instances of virtual environments across a plurality of electronic devices. GPU 140 may display the instance of the virtual environment via a display device 144. The display device 144 may include one or more monitors, specialized displays (e.g., a display of a mobile device, laptop, or other specialized devices), heads-up displays (e.g., virtual reality, augmented reality, etc.), and/or the like.

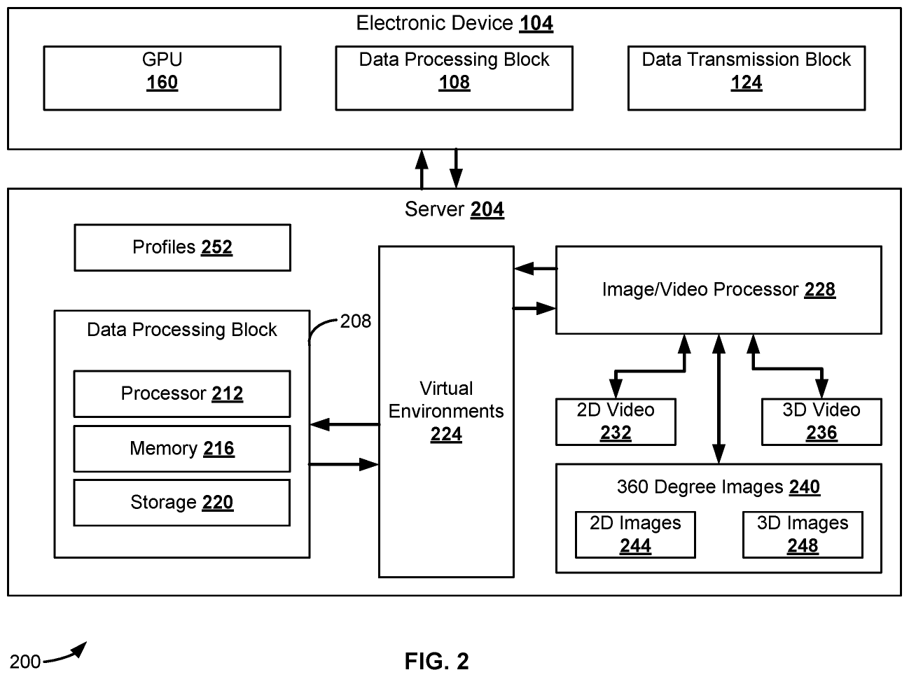

FIG. 2 shows a system 200 for generating and managing virtual environments for reducing implicit bias. In some instances, server 204 may provide functionality using components including, but not limited to data processing block 208, virtual environment 224, image/video processor 228, two dimensional video 232, three dimensional video 236, and 360 degree images 240. Server 204 may also include data storage such as one or more volatile or non-volatile memories, database, and/or the like.

Data processing block 208 may include one or more processors 212, memories, 216, and storage 220. Memories 216 may include one or more of volatile (e.g., random access memory), non-volatile memory (e.g., magnetic, flash, etc.), and/or combinations thereof as temporary memory for the one or more processors 212. For example, while executing an instances of a virtual environment 224, the one or more processors 212 may use memories 216 to store the contemporaneous state of the virtual environment 224 (e.g., location of users and non-playable characters within the environment, state of users and characters, state of particular on-going conversation or changes in the environment, etc.). In some examples, the state may also be stored in persistent storage 220 (e.g., external or internal storage of one or more magnetic, optical, flash, etc. disks). Tracking the state of each instance of the virtual environment enables connected user devices (and corresponding display devices) to maintain synchronized rendered views of the environment. For example, if one user alters the environment (e.g., changes a color of a door), the change will be stored within the state information and pushed out to all other electronic devices. Users of the other connected electronic devices will see the color of the door change in real-time.

Data processing block 208 may generate and maintain each instance of a plurality virtual environments 224. For example, an electronic device may transmit a signal to server 204 to generate new virtual environment given certain constraints. Data processing block 208 generate an instances of the virtual environment for the electronic device. In some examples, instances of virtual environments are maintained provided at least one user is connected. If the virtual environment is empty for longer than a predetermined period of time, the data processing block may store the contemporaneous state into persistent storage 220 and terminate the instance. Stored states of may be used to re-create older virtual environments. A user of an electronic device may select a state of an old virtual environment and the data processing block 208 may generate a new instance of the virtual environment having all of the properties of the old virtual environment at the time the state was stored.

Data processing block 208 may generate a new instance of a virtual environment 224 using image/video processor 228. Image/video processor 228 builds virtual environments from one or more images (e.g., real world or animated images). In some examples, the virtual environments are generated from images stored in 360 degree images 240 (e.g. two dimensional images 344 or three dimensional images 348). 360 degree images may be images taken using a 360 degree camera or generated from a plurality of images taken from different angles of the same location. For example, image/video processor 228 may execute a pixel analysis of two or more images by identifying the color value (red/blue/green value) and intensity (brightness) of each pixel. The pixel analysis may be used to merge the two images such that the combined image lacks any seam or distortion between the end of one image and the beginning of the next image. If a portion of the pixels (e.g., an edge of the image) of a first image matches a portion of the pixels (e.g., a corresponding edge) of a second image, the images may be merged without modifying the pixels of either image. If the portion of the pixels of the first image does not match the portion of pixels (e.g., corresponding edge) of the second image, then image/video processor 228 may modify either or both of the respective portions of pixels. For example, image/video processor 228 may modify a portion of the pixels of the first image and/or the second image or generate new pixels to bridge the gap between the respective portions of pixels to make seamless transition from the first image to the second image. The combined image may appear to be a single image. In some examples, two or more images may be joined to create a virtual environment. In other examples, image/video processor 228 may join thousands of images to render the virtual environment. The images received from a 360 degree camera (which takes images in multiple directions from a single location at once and automatically joins the images together to form a single image) may be joined with regular images or other images from a 360 degree camera. The resulting virtual environment may simulate a real world environment.

In some examples, server 204 may generate and maintain one or more virtual environments accessed by groups of remote users. Each user may connect to server 204 to access a particular virtual environment 224. For example, a user may connect to the server 204 using access credentials (e.g., username password, two-factor authentication, etc.). The access credentials may grant that user access to a particular instance of a particular virtual environment 224. For example, the user may be granted access to a particular instances of a particular virtual environment that is also accessible by a particular group (e.g., random users, the user's coworkers, the user's friends, the user's family members, users sharing one or more particular trait or characteristic, and/or user's selected by an administrator). The particular group may interact with each other and a plurality of non-player characters (NPCs) using the virtual environment. The access credentials may be used to control access to particular instances of virtual environments, particular types of virtual environments, or to restrict the user's interactions with other users (e.g., force the user to interact with particular user groups and not other user groups). Each instance of a virtual environment may support pre-selected number of simultaneous users (e.g. controlled by an administrator).

Although shown and described as being contained within server 204, it is contemplated that any or all of the components of server 204 may instead be implemented within electronic device 104, and vice versa. It is further contemplated that any or all of the functionalities described herein may be performed dynamically (e.g., at runtime) or statically (e.g., prior to runtime).

A Web Portal (not shown) may also be provided along with electronic 104 and server 204. The Web Portal may enable access to virtual enviromnents, other users, and user profiles 252. In some examples, the Web Portal may enable access to virtual environments from devices without the processes resources to generate or render virtual environments (e.g., mobile devices, thin clients, and the like). Web Portal may enable users across electronic devices to communicate (e.g., email, short messaging service, chat rooms, message boards, and/or the like).

Server 204 may include a database of profiles 252. Each user that connects to server 204 or access a virtual environment may have a profile stored in profiles 252. A profile may include identify a user, include some personal information, track a user's progress or interaction within a virtual environment. For example, a user's profile may include achievements and/or trophies that a user can share or with other users.

In some examples, virtual environments may enable a user to interact with the content within the virtual environment, other users, and/or other characters (non-user characters). Any number of characters and/or users may simultaneously connect to a single instance of a virtual environment allowing each user to interact with other users, administrators, presenters, and/or instructors using a virtual environment. The virtual environment may be an immersive interactive virtual relative multimedia platform (IIVRMMP) that may be used for education, classes, presentations, conferences, live chats, lectures, workplace training, therapeutic purposes, or personal development. Virtual environments may use evaluative algorithms to track changes in a user's bias before, during, and after use of the virtual environment. The virtual environment may enable users to chat (e.g., SMS, email, message boards, messaging applications, chat rooms, etc.) and cooperate with other users in the real world. Profiles of users of virtual environments may enable social sharing to allow users to compare their bias reduction results with others on different platforms (e.g., within the virtual environment, the Web Portal, user's profiles, social media platforms, etc.), using posts, achievements, trophies, and/or badges. Virtual environments may enable large groups of users to connect and interact providing a virtual location for web conferencing that allows users to interact with instructors, administrators and other users.

Virtual environments may include two dimensional and/or three dimensional 360 degree images or video that immerse users in a simulated real world environment (e.g., a workplace, a school, a hotel, theater, library, and/or any other location). The user can navigate the environment (in first or third person) and interact with nodes, objects, simulated non-user characters, user characters, etc. Users may navigate the environment to move to different areas, engage with content (e.g., text, images, video, etc.), play games (e.g., single or multiplayer), simulate interactions, have generate interactions (e.g., with other users), etc. In some examples, objects may operate as a portal that enables a user to interact with real or simulated characters (e.g. humans) in chat.

A user accessing a virtual environment may begin within a centralized location (e.g., a lobby, a concourse, a mall, or any other real world or animated environment) of the virtual environment. The centralized location may include a virtual guide that may accept text or natural language input and answer questions or direct users to other locations within the environment. For example, a user may ask where to find the library or if another user is currently online, etc. The centralized location may include chat and social sharing elements. For example, a wall within the virtual environment may render portions of user profiles enabling users to compare their progress within the virtual environment with other users. The centralized location may include nodes (e.g., doors) to other rooms (e.g., other areas of the virtual environment). In some examples, the centralized location may have a designated area for conferencing (e.g., where multiple users may congregate for meetings, lectures, collaborative simulations or discussion, etc.).

The virtual environment may include a plurality ancillary virtual locations (e.g., rooms) such as, by example only one or more libraries, theaters, game and simulation rooms. A library room may contain a plurality of types of content (e.g., documents, books, images, videos, etc.). The content may educate users on best practices to reduce unconscious bias as well as the science of implicit bias.

A theater room within the virtual environment may enable one or more users to view videos that the user can view. The videos may be selected based on the content of the video such as the content that promotes empathy or educates. The theater may appear as a movie theater having a plurality of seats. Users may occupy a seat while watching a video. In some examples, a plurality of users may watch a same video. In other examples, each user may generate a separate, unique instance of a theater within the same virtual environment such that users may watch different videos.

A games and simulation room within the virtual environment may include games designed to reduce unconscious bias, social simulations, and 360 immersive interactive experiences designed to promote empathy. Games may include two dimensional and three dimensional rendered environments within the virtual environment that may be designed to reduce implicit bias. Games may be used to motivate the user's brain by engaging in activities, which will over time, through neuroplasticity, overwrite biases and create new attitudes. In some examples games may include trophies, achievements, and/or badges that may be sharable (e.g., through social media, the user's profile, and/or the like). User may perform debasing activates while playing games, the repetition and self-motivating quality of the games enable retraining the unconscious bias within the user to make new connections and shift social categories.

Games and simulations may include single player or multiplayer games and/or simulations that, through use, cause users to form new mental connections that include paradigms where marginalized people are seen differently. For example, games may create a way for users to interact with images of members of marginalized groups in a way where the user has agency. The user may be tasked with behaving in scenarios that promote unbiased attitudes rather than simply viewing them passively. The agency of the user while interacting with the images in a game or simulation context, given the additional motivation of competition (e.g., an interest in winning), generates a mental environment that triggers changes in the unconscious attitudes towards marginalized groups. The games and/or simulations may incentives repetition to further improve debasing effect of playing the game.

Simulations may include simulated events (historical, contemporaneous real world, or administrator generated) and social simulations. For example, users may be presented with simulated social situations in a two dimensional, three dimensional, or 360 video virtual reality environment within the virtual environment. Users may interact with animated characters (e.g. simulated representation of a human) or video recorded human (e.g., a video recording seamlessly integrated into the virtual environment). Users may provide responses to dialog of an animated character or recorded human using text, selectable dialog options, selectable action options, natural language processed audio (e.g., the user may speak natural language response that may be parsed to provide a response in the simulated interaction), and/or the like. The user's response will result in corresponding reactions from the animated character or video recorded human inside the virtual environment. The dialog response available to the user and corresponding reactions may be designed to reduce implicit bias and/or promote empathy.

In some examples, users may be presented a two dimensional or three dimensional environment simulating a scene. Users may interact with one or more simulated characters (e.g., animated or live action humans) to teach behaviors corresponding to positive social interaction. In some instances, the scene may teach behaviors corresponding to positive social interactions in particular settings such as, but not limited to, a workplace, school, public space, social gathering, political gathering, and/or the like. Users may be presented with branching dialog and/or action options, which when selected, cause the character to response (e.g., through dialog, body language, and/or actions) that is based on the user's selected dialog or action option. Reactions may teach the user better social interaction according to the specific task objective (e.g., intercultural, gender, sexual orientation, etc. based conflict resolution). For example, the user may take on an appearance of a member of a marginalized group and through a he social interaction learn how other groups may interact with the marginalized group (e.g., generalizations, stigmas, biases, etc.).

The games and simulations room may include 360 video interaction in which a human may be recorded in the same setting as the virtual environment's real world environment. The recording may include the human acting out dialog and action possibilities that correspond to responses that the human would have given particular dialog input from a user. The virtual environment (or ImageNideo Processor 228) may identify groups of frames of the video corresponding to individual dialog or action responses and dynamically (e.g., at runtime while the user is interacting with the character representing the human) and seamlessly render the relevant group of frames corresponding to the relevant dialog or action response. The user may perceive an interactive dialog with another human within the virtual environment rather than a non-user character.

In some examples, users may embody (e.g., taken on an appearance of within the virtual environment) a character who is socially stigmatized. The may visually see the representation of the user within the virtual environment in that body in the first person (e.g., user may see limbs but not the entire body) or third person. The user may experience reactions from users or non-user characters within the virtual environment that corresponds to the embodied appearance of a stigmatized individual. The user's experiences may be as close to real life as possible to create actual memories and/or empathy.

The 360 video interaction may generate the most immersive environment possible to simulate real social interactions and to generate real memories in users. The real memories may reduce pre-existing implicit bias and/or generate empathy for the embodied character. This in turn may generate empathy for humans who are different from the user in real life.

Virtual environments (or server 204) may include a plurality of evaluation modules that execute to provide users and administrators with an indication as to a user or group's implicit bias. For example, the evaluation modules may include a natural language algorithm that captures a user's public online presence, an algorithm that tracks the user's progression through the virtual environment (e.g., content viewed, options selected, speed scores, user's reported mood and reactions to the content, etc.) and algorithms that test user's bias after using the platform.

A pre-use evaluation module may use a natural language processor that parses social media platforms (e.g., text, images, and videos posted by a user) to determine an initial level of bias in the user. The algorithm may incorporate machine learning concepts to improve natural language parsing and identification of initial bias level. For example, the longer the virtual environment and pre-use evaluation module executes, the more accurate the natural language processor and initial bias level may be.

A simultaneous-use evaluation module may use algorithms that calculates scores from a user's selection of dialog options and actions, timing of selecting options, interaction with the platform, interactions with other users, interactions with non-user characters (e.g, animated and/or simulated humans), user's reported mood during use of the virtual environment, user's reported reaction during use of the virtual environment, and/or any other characteristic or metric recorded by the virtual environment.

A post-use evaluation module may include tests to that identify evolving bias. For example, tests may include written questions (e.g., essay, short answer, multiple choice, etc.) and/or image/word or image/image exercises that evaluate bias. An algorithm may compare the pre-use evaluation and simultaneous-use evaluation to the post-use evaluation to generate a composite score of evolving bias. The algorithm may use data from previous evaluations (pre-use, simultaneous-use, and post-use) and composite scores to improve the accuracy of the composite score corresponding to evolving bias in a user. For example, the longer the virtual environment executes, the more accurate the composite score will be in corresponding to evolving bias.

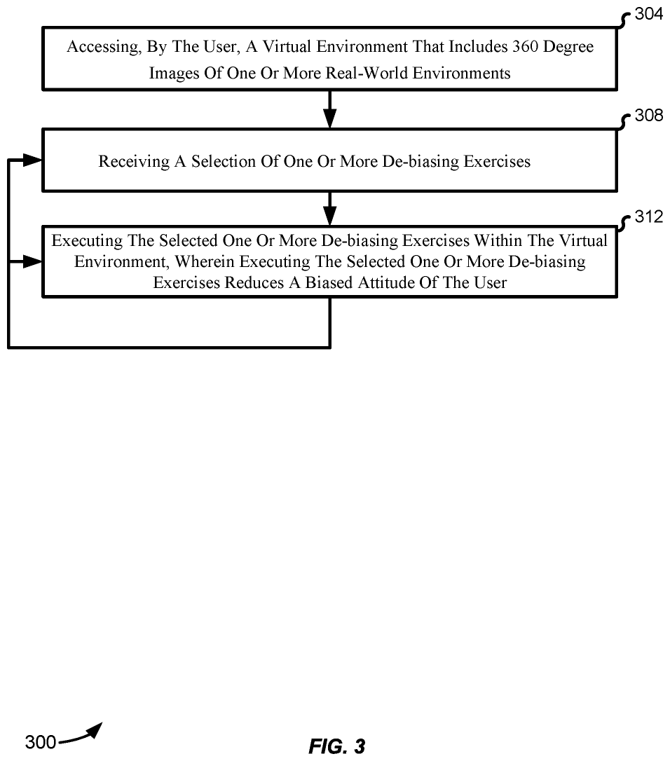

FIG. 3 depicts an exemplary flowchart of a process for reducing implicit bias using virtual environments. The process begins at block 304 in which a user access an instance of a virtual environment. The user may access the instance of the virtual environment using any electronic device (e.g., mobile device, laptop, desktop, etc.), which may render an isolated instance (e.g., isolated from other users) or a networked instance (e.g., with one or more other users also accessing the same instance of the virtual environment). The instance of the virtual environment) may be generated locally (e.g., entirely on the electronic device of the user), remotely (e.g., entirely on a server or other electronic device), or partially remotely and partially locally. The instance of the virtual environment may be generated using 360 degree images of one or more real-world environments. In some examples, the instance of the virtual environment may be rendered in two dimensions, three dimensions, partially in two dimensions and partially in three dimensions, are both in two dimensions and three dimensions (e.g., some devices may render the same instances of the virtual environment in two dimensions while other devices may render the virtual environment in three dimensions).

At block 308, the electronic device receives a selection of one or more de-biasing exercises. For example, the electronic device may receive a selection from a local man-machine interface (e.g., mouse, keyboard, touch screen, gesture input from an accelerometer and/or gyroscope, and/or the like), or from a remote device (e.g., from an administrators, presenters, and/or instructor). The one or more exercise may execute within the virtual environment and may include, but are not limited to: games social simulations and/or interactions, interacting with content (e.g., text, images, music, and/or video), attending a lecture or seminar, guided interactions with other users or groups, and/or the like. Any number of exercises may be selected for execution by a user and the instance of the virtual environment. For example, a selection of two different exercises may generate a playlist in which upon termination of the first exercise the second exercise may automatically initiate for the user. In some examples, if a plurality of exercises are selected, the instance of the virtual environment may trigger an option to be presented to the user as to which exercise to initiate next. [0048] At block 312, the first exercise of the one or more exercises that were selected is executed. For example, a social simulation may execute by modifying the appearance of the user with the instance of the virtual environment so the user appears as a member of a marginalized group. A character (e.g., animated or pre-recorded non-user character, a character operated by another user, or a character operated by administrators, presenters, and/or instructors) may be rendered within the environment and a scene may initiate in which the user is directed to complete an dialog interaction with the character. The user may select (or speak) dialog options and watch how the character responds (with dialog, body language, or actions). Once the social interaction terminates, if there is another de-biasing exercise in the one or more de-biasing exercising that has not executed, then that de-biasing exercise may automatically initiate (e.g., returning to block 312). In some examples, even if each of the one or more de-biasing exercise has executed, block 312 may repeat the executing the one or more de-biasing instructions for predetermined period of time or a predetermine number of iterations (e.g., selected by the user, administrators, presenters, and/or instructors). In other examples, when each of the one or more de-biasing exercise has executed the process may return to step 308 in which more de-biasing exercises may be selected. The process may return to blocks 308 and/or 312 any number of iterations. If each of the one or more de-biasing instructions has executed and no new exercises has been selected, the process terminates (e.g., the user disconnects from the instance of the virtual environment.

In some examples, after each exercise terminates a user profile of the user may automatically be updated. For example, upon completing the social simulation, the user may automatically receive an achievement, badge, and/or trophy that will be displayed to the user and to other users that view this user's profile. Some achievements, badges, and trophies may indicate completion of an individual or set number of exercise types (e.g., social simulations, games, etc.) while other achievements, badges, and trophies may correspond to a user's de-biasing progress. For example, some achievements, badges, and trophies may trigger upon an post-use evaluation test indicating that a particular biased attitude has been replaced with an unbiased attitude. The virtual environment (with the user's consent) may automatically share achievements, badges, and trophies with other users through a server (e.g., server 204) that connects the users of a particular instance of the virtual environment, on social media, on the users profile, inside the virtual environment, and/or the like.

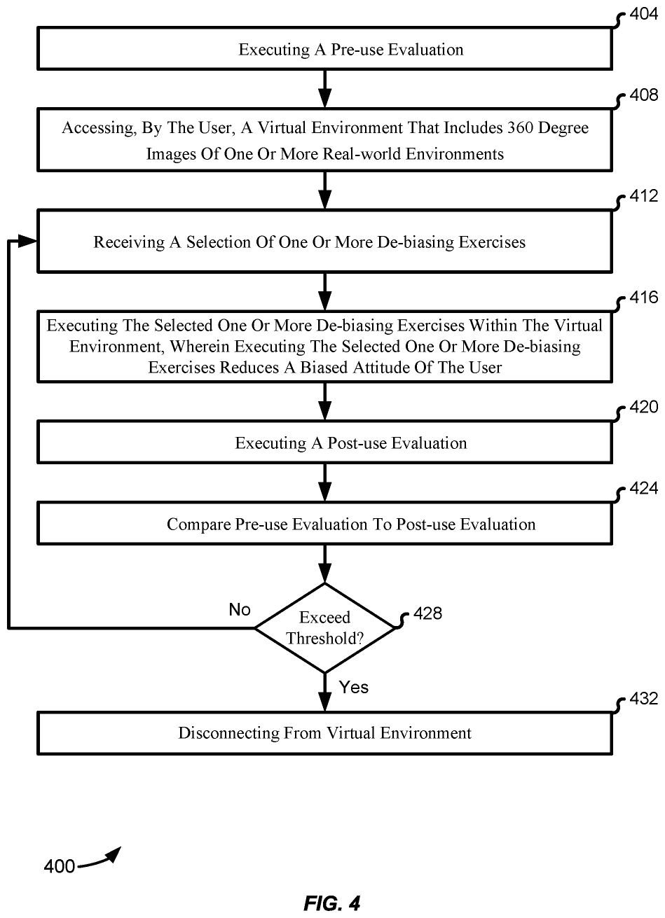

FIG. 4 depicts another exemplary flowchart of a process for reducing implicit bias using virtual environments. The process begins at block 404 where a pre-use evaluation is executed for a user. A pre-use evaluation includes a natural language algorithm that parses one or more online posts authored by the user. For example, the natural language algorithm may access social media platforms frequented by the user and review posts, articles, and other texts, authored by the user. The algorithm may additionally review posts of friends and/or family of the user on the user's social media profiles as well as stored conversations of the user. The algorithm may parse each post, article, other text, and conversation and assigning a score. The scores may be aggregated to identify a composite score associated with a current biased attitude of the user. In some examples, the algorithm may include machine learning concepts that improve the accuracy of score assigned to posts (e.g., the quality of the natural language parser in detecting bias in text strings) by evaluating large datasets of text. The more pre-use evaluations executed the more accurate the resulting composite score will be in identifying a biased attitude.

At block 408, a user access an instance of a virtual environment (e.g., this block may proceed in a similar or same manner as described in connection with FIG. 3, 304).

At block 412, a selection of one or more de-biasing exercises is received (e.g., this block may proceed in a similar or same manner as described in connection with FIG. 3, 308).

At block 416, the one or more de-biasing exercises are executed within the virtual environment (e.g., this block may proceed in a similar or same manner as described in connection with FIG. 3, 312). In some examples, a simultaneous-use evaluation may be executed during execution of the one or more de-biasing exercises (e.g., during an exercise or between exercises). A simultaneous-use evaluation may include one or more algorithms that track, choices or options selected by the user, timing of the choices or options, interactions with the virtual environment, a mood of the user, reactions of the user to the virtual environment, and/or the like to determine a progress of the user during execution of the one or more exercises (or even when before or after the exercises execute when the user is simply interacting with the virtual environment.

At block 420 and upon termination of the one or more de-biasing exercises, a post-use evaluation may be executed. The post-use evaluation may include a post-use test for evolving bias. A post-use test may include questions (e.g., multiple choice, short answer, essay, fill in the blank, image/word association, image/image association, and/or the like). The post-use evaluation may generate a score indicating a current evolving bias in the user (e.g., a measure between a biased attitude and an un-biased attitude for each of a plurality of biases).

At block 424, the pre-use evaluation and the simultaneous-use evaluation (if present) are compared to the post-use evaluation. For example, an algorithm may generate a composite score for a user based on the pre-use evaluation and simultaneous-use evaluation (if present). The composite score may be normalized such that the normalized composite score can be compared to the post-use test. For example, the units of measurement, scale, weight, format etc. of the composite score may be modified to enable the comparison with post-use test. Comparing the pre-use and simultaneous-use evaluations to the post-use test may provide an indication of a user's progress in reducing or eliminating a biased attitude. In some examples, evaluations and their comparison may correspond to a single bias or to a plurality of biases.

At block 428, the comparison may evaluated to determine if the reduction in a biased attitude of the user exceeds a threshold amount. The threshold amount may be automatically set, set by the user, administrators, presenters, or instructors. If the comparison of the pre-use evaluation and contemporaneous-use evaluation (if present) to the post-use evaluation, then the user, administrators, presenters, or instructors may be presented with an option to repeat the one or more de-biasing exercises (e.g., returning to block 416) or to select one or more new de-biasing exercises (e.g., returning to block 412). For example, the post-use evaluation may provide an indication that the one or more de-biasing exercises that were selected were not effective in reducing the bias attitude of the user (or a group of users) and return to block 412 to select a new (and different) collection of one or more de-biasing exercises that may be more effective for this particular user (or group). The process may repeat (e.g., block 412-428) until the comparison of the pre-use evaluation and contemporaneous-use evaluation (if present) to the post-use evaluation exceeds the threshold amount. In some examples, the process may stop repeating (e.g., move to block 432) after a particular number of iterations, particular number of exercises are executed, sand/or a predetermine period of time elapses. In some examples, blocks 412-424 may repeat regardless of the comparison to the threshold amount based on a particular number of iterations, particular number of exercises are executed, sand/or a predetermine period of time elapses.

At block 432, the user may disconnect from the instance of the virtual environment and the process terminates.

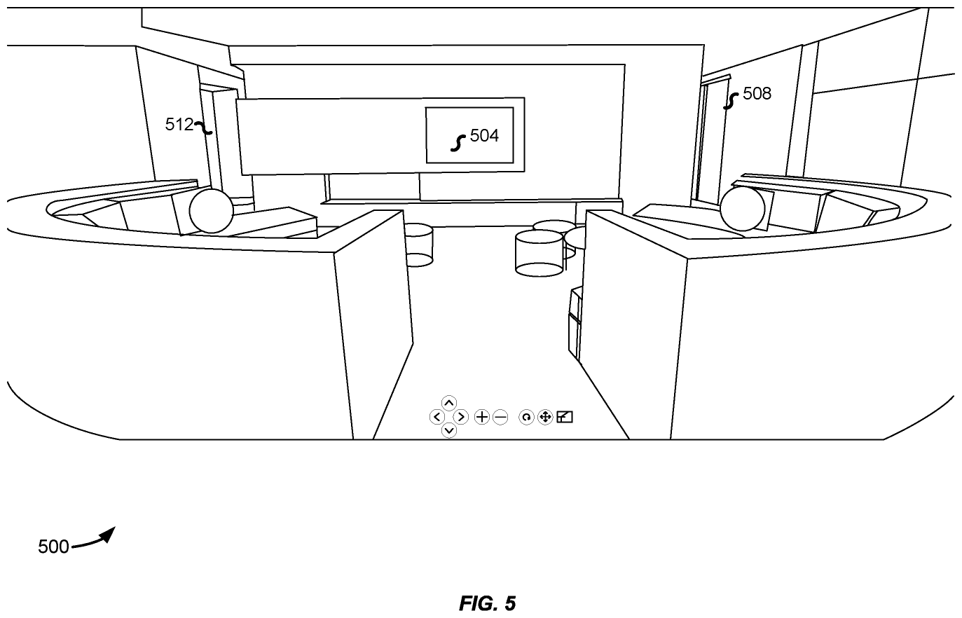

FIG. 5 depicts an exemplary view of a virtual environment as it appears to a user of the virtual environment. FIG. 5 depicts a lobby area having a plurality of selectable objects. A user may appear within the environment in the first person (as depicted in FIG. 5) or in the third person in which the user may see the back of the character the user is embodying. The user may navigate (e.g., in which the user's character walks or runs within the environment) to any area of the virtual environment. In some examples, the user may walk to a selectable exercise or other interaction location in order to initiate a particular action, social simulation or interaction, exercise, class, lecture, conference, video, etc. In other examples, the user may select within the virtual environment (e.g., using a interface device such as a mouse or keyboard) to initiate the particular action, social simulation or interaction, exercise, class, lecture, conference, video, etc.

The virtual environment may include a plurality of disparate selectable interactions. For example, the virtual environment may include a simulated television 504 that a user may select to view tutorial, talk to a virtual assistant or concierge, see a map of the virtual environment, view user profiles of the user and/or other users accessing the virtual environment, to enter a video conference, to chat, and/or to execute any other task or exercise within the environment. Doors throughout the virtual environment may transport the user to other areas. In some examples, the virtual environment is seamless (e.g., the user may walk around in the same manner as traveling from one room to the next in real life). In other examples, the user may select a particular doorway and the virtual environment may pause to load a new 360 degree imaged view of the environment (e.g., a movie theater, a library, a game room, etc.). The user would automatically appear within the new room instead of walking through the lobby to the new room. Rooms 508 and 512 may be any rooms such as (e.g., a movie theater, a library, a game room, etc.). In some examples, the rooms may be dynamically determined based on an access level of the user (e.g., the user is only authorized for a library and no movie theater), an administrator, instructor, etc. Although FIG. 5 depicts a particular view of the virtual environment, the virtual environment may take on any appearance of a real world environment (e.g., an office, a store, a classroom, the outdoors, or any real world image). Any such image (360 degree or otherwise) to generate a virtual environment for one or more users (according to the above disclosure of FIG. 1 and FIG. 2).

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within, the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of reducing bias in a user, the method comprising:
accessing, by the user, a virtual environment that includes 360 degree images of one or more real-world environments;
receiving a selection of one or more de-biasing exercises;
executing the selected one or more de-biasing exercises within the virtual environment, wherein executing the selected one or more de-biasing exercises reduces a biased attitude of the user; and
repeating the selected one or more de-biasing exercises, wherein repeating the selected one or more de-biasing exercises replaces the biased attitude with an unbiased attitude.

2. The method of claim 1, wherein the de-biasing exercises include a word to image exercise in which the user is presented with images and words within the virtual environment, wherein the virtual environment is configured to enable the user to interact with the images and the words, and wherein the user forms associations between the images and the words to create positive mental associations toward marginalized people.

3. The method of claim 1, wherein the de-biasing exercises include a perspective taking exercise in which the user, within the virtual environment, appears as a marginalized person and receives social feedback corresponding to the marginalized person.

4. The method of claim 1, wherein the de-biasing exercises include a counter stereotypical imagery exercise in which images of a marginalized person are displayed to the user within the virtual environment, wherein the user interacts with the images within the virtual environment, and wherein the marginalized person is represented in a counter stereotypical role or scenario.

5. The method of claim 1, wherein the de-biasing exercises includes an individualization exercise in which the user is presented with facts associated with a marginalized person in a scenario, wherein the scenario represents the marginalized person as an individual that is separate from a group of which the marginalized person belongs.

6. The method of claim 1, wherein the de-biasing exercises include a team building exercise in which the user is presented, within the virtual environment, with attributes associated with a marginalized person that are similar to attributes associated with the user.

7. The method of claim 1, wherein the de-biasing exercises include a conversation exercise in which the user interacts with a character in the virtual environment by selecting dialog options in response to dialog presented by the character, wherein the character is represented as a marginalized person, and wherein the conversation exercise simulates building respect and rapport with the character.

8. The method of claim 7, wherein the character is animated by superimposing pre-recorded video of an actor playing the character onto a 360 degree image.

9. The method of claim 7, wherein each dialog option selected by the user causes a corresponding reaction in the character, and wherein the selected dialog options and reactions in the character are designed to reduce implicit bias and promote empathy.

10. The method of claim 7, wherein the user interacts with the character in a two dimensional representation of the virtual environment, two dimensional representation of the virtual environment, or a virtual reality representation of the virtual environment.

11. The method of claim 1, further comprising:
executing a pre-use evaluation including a natural language algorithm that parses one or more online posts authored by the user, the pre-use evaluation executing before user access the virtual environment.

12. The method of claim 11, further comprising:
executing a simultaneous-use evaluation including an algorithm that tracks, one or more choices selected by the user, timing of the one or more choices, interaction with the virtual environment, a mood of the user, and/or a reaction of the user to the virtual environment, simultaneous-use evaluation executing during use of the virtual environment by the user.

13. The method of claim 12, further comprising:
executing a post-use evaluation including a post-use test for evolving bias, the post-use test including written questions, image to word, and/or image to image associations exercises to evaluate bias, the post-use evaluation further including an algorithm that compares the pre-use evaluation and simultaneous-use evaluation to the post-use test to generate a score of evolving bias.

14. The method of claim 1, wherein the virtual environment is configured to enable a plurality of users to simultaneously access the virtual environment and to interact with each other and one or more of administrators, presenters, and/or instructors.

15. The method of claim 14, wherein the virtual environment includes a voice or text interface that enables one or more of the plurality of users to communicate with one or more of other users, administrators, presenters, and/or instructors.

16. The method of claim 1, further comprising:
generating a profile for the user, the profile including an indication of a bias reduction result caused by executing the selected one or more de-biasing exercises.

17. The method of claim 16, further comprising:
displaying a user-interface to the user, the user interface providing a comparison between the indication of the bias reduction result associated with the user and one or more indications of bias reduction results corresponding to other users.

18. The method of claim 16, wherein the profile includes one or more trophies and/or badges earned by the user through executing de-biasing exercises, the one or more trophies and/or badges.

19. The method of claim 1, wherein one or more of the de-biasing exercises are executed in a 360 degree video virtual reality representation of the virtual environment.

20. A system comprising:
one or more processors
a non-transitory computer-readable medium including instructions which, when executed by the one or more processors, cause the one or more processors to perform operations including:
accessing, by a user, a virtual environment that includes 360 degree images of one or more real-world environments;
receiving a selection of one or more de-biasing exercises;
executing the selected one or more de-biasing exercises, wherein executing the selected one or more de-biasing exercises reduces a biased attitude of the user; and
repeating the selected one or more de-biasing exercises, wherein repeating the selected one or more de-biasing exercises replaces the biased attitude with an unbiased attitude.
